(19) United States
(12) Patent Application Publication
(10) Pub. No.: US 2021/0061357 A1
(43) Pub. Date: Mar. 4, 2021

(54) EXPANDABLE VEHICLE FRAME

(71) Applicant: Club Car, LLC, Evans, GA (US)

(72) Inventors: Benjamin Gilling Braun, Evans, GA (US); Samuel Ross Lyons, Evans, GA (US); William Reeves, JR., Grovetown, GA (US); Gregory James Lacock, Augusta, GA (US); Justin Thigpen, Grovetown, GA (US)

(21) Appl. No.: 16/555,383

(22) Filed: Aug. 29, 2019

(51) Int. Cl. B62D 21/14

(52) U.S. Cl. CPC B62D 21/14

(57) ABSTRACT

A system and method for expanding a frame of a vehicle at least after partial assembly of the vehicle along an assembly line. The frame includes opposing first and second side rail assemblies that are, during at least initial assembly, in a first configuration that comprises, for each side rail assembly, a removable first insert mechanically coupled to front and rear sections of the side rail assembly. The vehicle can be selectively separated and expanded to a second configuration via the first insert being detached from, and a second insert instead being attached to, one of the front and rear sections. The first and second inserts can be coupled to opposing ends of a rail sleeve that is positioned between the front and rear sections. A supplementary floor pan that can be coupled to additional seat can positioned over the rail sleeve.

### FIELD OF INVENTION

The present invention relates to manufacturing and assembly of vehicles, and more particularly, to manufacturing and assembly of vehicles having selectively expandable frames that can accommodate at least partial assembly along a common assembly line with vehicles having different final frame lengths.

### BACKGROUND

For at least certain types of vehicles, the use and/or capacity of the vehicle can be influenced by the overall length of the vehicle. For example, the length of a vehicle can influence, if not dictate, the seating and/or storage capacity of the vehicle. However, from at least a vehicle manufacturing and/or assembly perspective, vehicles of different lengths may be unable to be manufactured and/or assembled on the same production lines, which could negatively affect at least the costs and difficulties associated with production of such vehicles. One traditional manner of addressing such issues has been seeking custom modifications to the vehicle after the completion of the manufacturing and assembly processes, including after-market custom modifications following purchase of the vehicle from the manufacturer of the vehicle. However, such custom modifications can be costly and time consuming. Accordingly, there remains a need for further contributions in this area of technology.

### BRIEF SUMMARY

An aspect of an embodiment of the present application is a device that can include a frame assembly having a first side rail assembly and a second side rail assembly. The first side rail assembly and the second side rail assembly can be positioned on opposing sides of the frame assembly. Additionally, the first side rail assembly and the second side rail assembly each can be selectively expandable from a first configuration to a second configuration. Further, the first configuration for each of the first side rail assembly and the second side rail assembly can comprise a front section, a first insert, and a rear section, the first insert being selectively, and removably, attached to both the front section and the rear section. The second configuration for each of the first side rail assembly and the second side rail assembly can comprise the front section, the first insert, the rear section, a second insert, and a rail sleeve. With the second configuration, the first insert can be selectively, and removably, attached to one of the front and the rear sections and the second insert can be selectively, and removably, attached to the other of the front and rear sections. The rail sleeve can be coupled to the first insert and the second insert and positioned between the front and rear sections. Additionally, a length between opposing ends of the first side rail assembly and the second side rail assembly for the second configuration can be larger than a corresponding length for the first configuration.

Another aspect of an embodiment of the present application is a method that can include assembling, using a plurality of mechanical fasteners, a first side rail assembly and a second side rail assembly of a frame assembly, and mounting a plurality of vehicle components to the frame assembly to provide an at least partially assembled vehicle. Further, at least some of the plurality of mechanical fasteners can be removed after providing the at least partially assembled vehicle such that a portion of each of the first side rail assembly and the second side rail assembly can be disconnected from another portion of the associated first side rail assembly and the second side rail assembly. The frame assembly can be expanded by reconnecting the disconnected portions of each of the first side rail assembly and the second side rail assembly to at least a rail sleeve that is positioned at least between a portion of each of the previously disconnected portions of the first side rail assembly and the second side rail assembly

These and other aspects of the present application will be better understood in view of the drawings and following detailed description.

### BRIEF DESCRIPTION OF THE DRAWINGS

The description herein makes reference to the accompanying figures wherein like reference numerals refer to like parts throughout the several views.

FIG. 1 illustrates an exploded perspective view of components for a first configuration of an exemplary side rail assembly of a frame assembly according to an embodiment of the present application.

FIG. 2 illustrates a perspective view of a portion of at least some of the components for the first configuration of the side rail assembly shown in FIG. 1.

FIG. 3A illustrates a cross-sectional view of a portion of a first insert of a side rail assembly according to an illustrated embodiment of the subject application.

FIG. 3B illustrates a cross-sectional view of a portion of the front and/or rear sections of the side rail assembly shown in FIG. 1.

FIG. 3C illustrates a cross-sectional view of a portion of the side rail assembly shown in FIG. 1.

FIG. 4 illustrates a perspective view of a portion of an exemplary frame assembly having a pair of side rail assemblies each in a first configuration according to an embodiment of the present application.

FIG. 5 illustrates an exploded perspective view of components for a second configuration of the exemplary side rail assembly according to an embodiment of the present application.

FIG. 6 illustrates a perspective view of a portion of at least some of the components for the second configuration of the side rail assembly.

FIG. 7 illustrates a perspective view of the frame assembly shown in FIG. 4 expanded to a second, longer length via the pair of side rail assemblies each being in the second configuration.

FIG. 8 illustrates a top view of an exemplary assembled frame assembly having side rail assemblies in a first configuration according to an embodiment of the present application.

FIG. 9 illustrates a side view of the assembled frame assembly shown in FIG. 8.

FIG. 10 illustrates a perspective side view of an exemplary vehicle that is at least partially assembled on a frame assembly having side rail assemblies at a first configuration according to an illustrated embodiment of the subject application.

FIG. 11 illustrates a bottom side view of the partially assembled vehicle shown in FIG. 10.

FIG. 12 illustrates the frame assembly shown in FIG. 8 in a partially disassembled state and with additional components for expansion of the side rail assemblies, and thus the frame assembly, to a second, longer configuration according to an embodiment of the present application.

FIG. 13 illustrates the partially assembled vehicle shown in FIG. 10 with the frame assembly disconnected and prior to expansion in a length of the vehicle.

FIG. 14 illustrates a partially exploded bottom side view of the disconnected frame assembly shown in FIG. 13 with additional side rail components for the second, expanded configuration of the side rail assemblies.

FIG. 15 illustrates a top side view of the exemplary frame assembly shown in FIGS. 8 and 9 with the side rail assemblies each expanded to the second configuration.

FIG. 16 illustrates a perspective side view of the vehicle shown in FIGS. 10 and 13 after the vehicle has been expanded via the side rail assemblies being in the second, longer configuration.

FIG. 17 illustrates a bottom side view of the vehicle shown in FIG. 16.

FIG. 18 illustrates a top view of the exemplary assembled frame shown in FIGS. 8, 12, and 15 with the side rail assemblies each expanded to the second configuration, and further including a supplementary floor pan over an expanded region of the frame assembly.

FIG. 19 illustrates a side view of the assembled frame assembly shown in FIG. 18.

FIG. 20 illustrates a top side perspective view of the assembled frame assembly shown in FIG. 18.

FIG. 21 illustrates a bottom side perspective view of the assembled frame assembly shown in FIG. 20.

FIG. 22 illustrates a front side perspective view of an exemplary supplementary floor pan and supplementary bench seat frame for an expanded portion of the vehicle shown in FIG. 20.

FIG. 23 illustrates a bottom side view of a vehicle having a frame assembly with side rails in a second, expanded configuration and including a universal shifter cable for coupling to at least a component in, or around, an engine compartment and a driver accessible shifter assembly according to an embodiment of the subject application.

FIG. 24 illustrates a driver accessible shifter assembly mounted to a bench seat frame.

FIG. 25 illustrates an exemplary assembled vehicle having a frame assembly with side rail assemblies in a first configuration.

FIG. 26 illustrates an exemplary assembled vehicle having a frame assembly with side rail assemblies in a second configuration.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

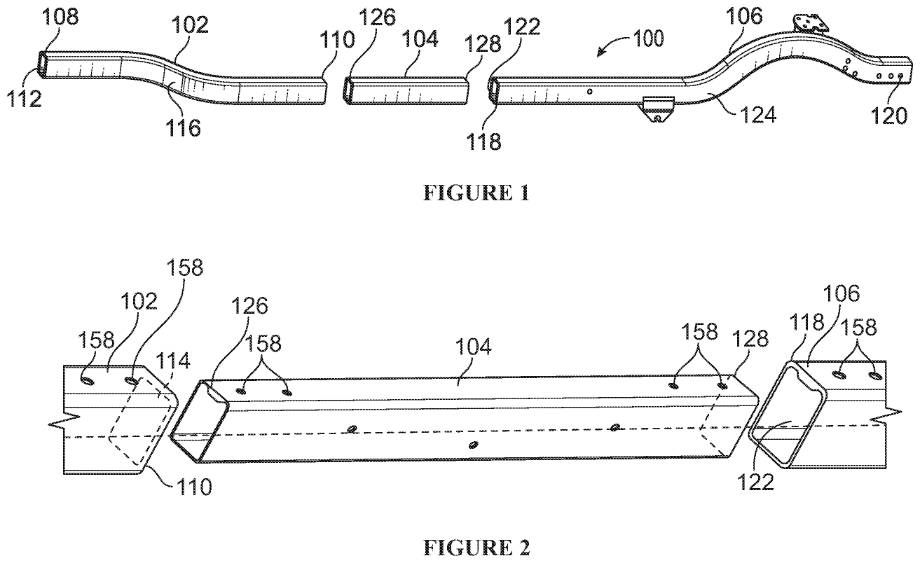

FIG. 1 illustrates an exploded perspective view of components for a first configuration of an exemplary frame, beam, or side rail assembly 100 according to an embodiment of the present application. One or more such side rail assemblies 100 can be utilized as part of a frame or chassis that is the primary support structure for a vehicle. The type of frames or chassis that utilize the depicted side rail assembly 100 can vary, and can include, for example ladder and perimeter frames, among other types of frames. Additionally, the frame, which may comprise a frame assembly having one or more such side rail assemblies 100, can be used with frames for a variety of different types of vehicles, including, but not limited to, motorized and non-motorized vehicles. Such motorized vehicles can include, for example, vehicles that are motorized or otherwise powered via use of electrical power, batteries, internal combustion engines, renewal energy sources, and/or combinations thereof, in addition to other manners of motorization. Further, such vehicles can be adapted for a variety of different types of applications and/or uses, including, for example, being a motorized golf car or cart, utility vehicle, a fully autonomous vehicle, small all-terrain utility vehicle, a neighborhood vehicle, and/or light utility passenger vehicle, among other types of vehicles.

The side rail assembly 100 shown in FIG. 1, as well as other components of the associated frame, can be constructed from a variety of different materials, including, but not limited to, carbon steel, aluminum, and aluminum alloys, among other materials. Further, the side rail assembly 100 can have a variety of shapes, sizes, and contours. For example, at least a portion of the side rail assembly 100 can be constructed from metal tubing, including, but not limited to, extruded rectangular tubing. Alternatively, at least a portion of the side rail assembly 100 can comprise C-shaped, U-shaped, or boxed side rails. Further, the side rail assembly 100 can be shaped and oriented to accommodate placement of the side rail assembly 100 along, over, and/or around certain components of the associated vehicle, including, for example wheels and tires, among other components.

According to the exemplary embodiment depicted in FIG. 1, the side rail assembly 100 can, for at least a first configuration of the side rail assembly 100, include a front section 102, a first insert 104, and a rear section 106. The front section 102 and rear section 106 can, for example, correspond to a front end and a rear end, respectively, of the associated vehicle. Additionally, as discussed below, the first insert 104 can be used to selectively connect, and detach, the front section 102 from the rear section 106.

The front section 102 can extend from a first end 108 to a second end 110 of the front section 102. Further, according to the illustrated embodiment, the front section 102 has a tubular construction. Thus, the front section 102 can have a first opening 112 and the first end 108, and a second opening 114 (FIG. 2) at the second end 112 that may each be generally defined by a wall thickness and/or shape of the tubing of the front section 102. Additionally, as shown in FIG. 1, according to the exemplary embodiment, a front transition section 116 is disposed between the first end 108 and the second end 110 of the front section 102 that at least inwardly offsets at least a portion of the front section 102 around the first end 108 from at least the second end 110 of the front section 102. In the illustrated embodiment, this front transition section 116 has shape that such that the portions of the front section 102 on opposing sides of the front transition section 116 may generally be parallel to, and offset from, each other. The front transition section 116 can be configured to accommodate placement of the front section 102 along, or around, a number of components of the vehicle, including, for example, placement at a location that does not interfere with, or otherwise will go around, the adjacent front wheel/tire of the vehicle.

The rear section 106 also extends from a first end 118 to a second end 120 of the rear section 106 and, according to the illustrated embodiment, has a tubular construction. Thus, the rear section 106 can have a first opening 122 and the first end 118 that can be generally defined by a wall thickness and/or shape of tubing of the rear section 106. Further, according to certain embodiments, at least the first opening 122 of the rear section 106 and the second opening 114 of the front section 102 can have similar shapes and sizes. As shown in FIG. 1, according to the exemplary embodiment, a rear transition section 124 is disposed between the first end 118 and the second end 120 of the rear section 106 that at least upwardly offsets at least a portion of the rear section 106 between the first end 118 and the second end 120 of the rear section 106. In the illustrated embodiment, this rear transition section 124 has a generally partial circular or round shape such that the portions of the rear section 106 along the rear transition section 124 can extend around at least an adjacent rear wheel/tire of the vehicle, or associated wheel well.

According to certain embodiments, the front and rear sections 102, 106 can at least initially, be formed, including extruded, as a single unitary or monolithic piece that is subsequently separated, such as, for example, cut, to form the separate front and rear sections 102, 106. Thus, at least at the location of such separation, the front and rear sections 102, 106, including associated openings 112, 122 of the front and rear sections 102, 106 at or around the location of the separation, can have similar shapes, sizes, and/or configurations.

As seen in FIGS. 1 and 2, the first insert 104 extends between first and second ends 126, 128 of the first insert 104. According to the illustrated embodiment, at least the first end 126 of the first insert 104 is size and configured to matingly engage the second end 110 of the front section 102, while the second end 128 of the first insert 104 is sized and configured to matingly engage the first end 118 of the rear section 106. Such engagement can, for example, involve the first end 126 of the first insert 104 being slid into the second opening 114 of the front section 102, or, alternatively, the first end 126 of the first insert 104 being slid over the second end 114 of the front section 102, until the first insert 104 is at a linear positon relative to the front section 102 that can facilitate a mechanical connection between the front section 102 and the first insert 104. Similarly, such engagement can also involve the second end 128 of the first insert 104 being slid into the first opening 122 of the rear section 106, or, alternatively, the second end 128 of the first insert 104 being slid over the first end 118 of the rear section 106 until the first insert 104 is at a linear positon relative to the rear section 106 that can facilitate a mechanical connection between the rear section 106 and the first insert 104.

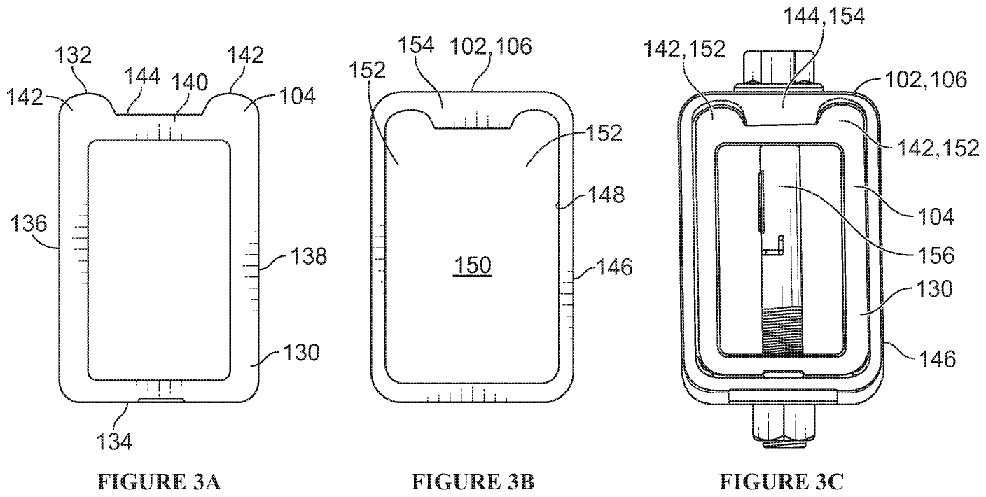

Referencing FIGS. 3A-3C, according to certain embodiments, the front section 102, insert 104, and rear section 106 can be formed to have shapes that can minimize, if not eliminate, the presence of shims between the first insert 104 and each of the front section 102 and rear section 106. For example, as shown in at least FIG. 3A, the first insert 104 can have wall 130 that includes a top portion 132 and an opposing bottom portion 134, the top and bottoms portions 132, 134 being connected by opposing first and second sidewalls 136, 138 of the wall 130. An outer surface 140 of the wall 130 can include at least one generally outwardly extending protrusion 142. Moreover, in the illustrated example, the outer surface 140 of the top portion 132 of the wall 130 of the first insert 104 can include two protrusions 142 that are separated from each other such that a channel or depression 144 is formed between the protrusions 142 along the top portion 132 of the wall 130. According to certain embodiments, the protrusions 142 can run the length of the first insert 104, and/or along at least the portions of the first insert 104 that will be matingly engaged with the front and rear sections 102, 106 of the side rail assembly 100. While the illustrated embodiment depicts the protrusions 142 and associated channel or depression 144 being position on the outer surface 140 of the top portion 132 of the wall 130, the location, position, and number of protrusions 142 and channels or depressions 144 can vary.

Referencing FIG. 3B, the front and rear sections 102, 106 of the side rail assembly 100 can include a wall 146, which, according to the illustrated embodiment, is generally formed in a rectangular tubular shape. As shown, for example, by at least FIG. 3C, the inner surface 148 of the wall 146 can generally define an inner region 150 of the front and rear sections 102, 106, and can have a size and configuration that matingly receives insertion of the outer surface 140 of the wall 130 of the first insert 104. The inner surface 148 of the wall 146 of the front and rear sections 102, 106 can thus have one or more recesses 152 and protrusions 154 that are positioned and sized to matingly receive, and possibly engage, the corresponding protrusions 142 and associated channel or depression 144 of the first insert 104. Further, the recesses 152 and protrusions 154 of the inner surface 148 of the wall 146 of each of the front and rear sections 102, 106 can extend the entire length of the front and rear sections 102, 106, or, alternatively, extend a length that, at a minimum, can accommodate insertion of the first insert 104 to a position at which the insert 104 can be coupled, such as, for example, by a mechanical fastener 156, to the corresponding front or rear section 102, 106. The protrusions 142 and associated channel or depression 144 of the first insert 104, and the corresponding one or more recesses 152 and protrusions 154 of the front and rear sections 102, 106, can be sized relative to each other so as to minimize, or otherwise control, the degree of at least lateral and vertical movement of the first insert 104 relative to the front and rear sections 102, 106. For example, the size and/or shape of such features can cause abutting or interfering engagements that restrict, if not prohibit, vertical and/or lateral movement of the either the first insert 104 relative to the corresponding front or rear section 102, 106, and vice versa.

According to certain embodiments, with respect to a first configuration of the side rail assembly 100, during assembly a portion of the first insert 104 at least around the first end 126 of the first insert 104 can be received within the second opening 114 at the second end 110 of the front section 102. Further, the inserted first insert 104 can be linearly displaced relative to the front section 102 at least until the first insert 104 is inserted a depth into front section 102 at which one or more fastener holes 158 of the first insert 104 are aligned with one or more fastener holes 158 of the front section 102. With the corresponding fastener holes 158 of the first insert 104 and the front section 102 aligned, a mechanical fastener 156 can be extended into and/or through each of one or more of the aligned fastener holes 158, and thus through both the first insert 104 and the front section 102. For example, FIG. 3C illustrates a fastener 156 that extends through aligned fastener holes 158 (FIG. 2) in the top and bottom portions 132, 134 of the first insert 104 and adjacent portions of the wall 146 of the front or rear section 102, 106. A variety of different types of fasteners 156 can be utilized, including, but not limited to, bolts, screws, and pins, among other fasteners. For example, according to certain embodiments, the fasteners 156 can include 7×M8 bolt and nut combinations, 9×M10 bolt and nut combinations, and/or 2×M10 bolt and nut combinations, among other sizes and types of fasteners. Additionally, the mechanical fasteners 156 can be in a variety of orientations relative to at least the front and rear sections 102, 106 and the first insert 104, including, but not limited, vertical and horizontal configurations, as well as combinations thereof, among other configurations.

While the above examples are discussed in terms of connecting the first insert 104 to the front section 102, a portion of the first insert 104 can also be connected to the rear section 106 in a manner that is generally similar to the connection between the first insert 104 and the front section 102. For example, according to certain embodiments, at least the second end 128 of the first insert 104 can have a shape and configuration that accommodates at least the second end 128 of the first insert 104 being inserted into the first opening 122 at the first end 118 of the rear section 106, as well as displaced relative to the rear section 106 such a portion of the first insert 104 is at distance within the rear section 106 that accommodates alignment of a one or more of the fastener holes 158 of the first insert 104 with one or more fastener holes 158 of the rear section 106. According to certain embodiments, with the fastener holes 158 of the first insert 104 and the rear section 106 aligned, mechanical fasteners 156 can extend through those aligned fastener holes 158, and thus into and/or through both the first insert 104 and the rear section 106.

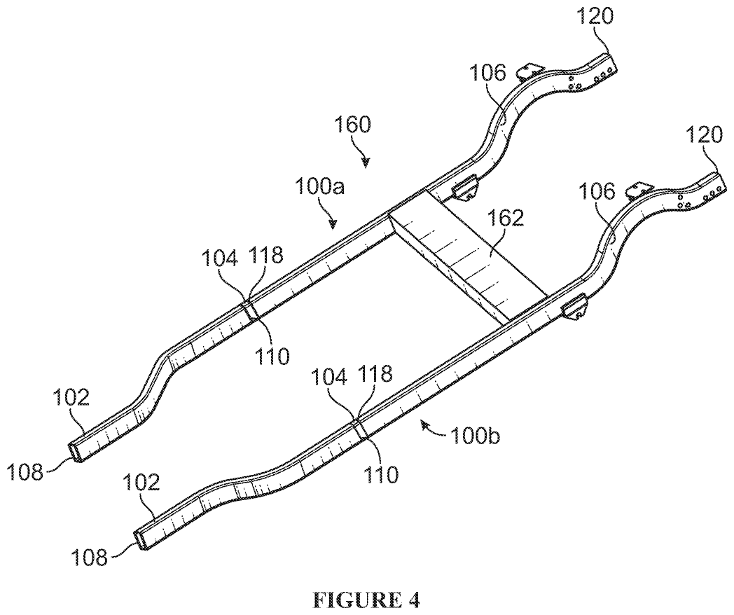

FIG. 4 illustrates a perspective view of a portion of an exemplary frame assembly 160 having first and second side rail assemblies 100a, 100b. As shown, the first and second side rail assemblies 100a, 100b are both in a first configuration, such as a configuration similar to that discussed above with respect to side rail assembly 100 shown in FIGS. 1-3C. Accordingly, the first insert 104 for each of the first and second side rail assemblies 100a, 100b is directly attached to both of the associated front and rear sections 102, 106 of the frame assembly 160. With the first insert 104 connected to the front and rear sections 102, 106 of the respective side rail assembly 100a, 100b, the first and second side rail assemblies 100a, 100b, as well as at least the overall frame assembly 160, can be in a first configuration. When the first and second side rail assemblies 100a, 100b, and thus the frame assembly 100 is in the first configurator, the assembled side rail assemblies 100a, 100b, and thus the frame assembly 160, have a first overall length, such as, for example, a first linear length between the first end 108 of the front section 102 and the second end 120 of the rear section 106.

In the depicted embodiment, the first and second side rail assemblies 100a, 100b are generally mirror images of each other. However, according to other embodiments, the first and second side rail assemblies 100a, 100b can have different configurations and/or features, such as, for example, features that can accommodate connections of different components, or connections at different locations of components, of the associated vehicle to each of the side rail assemblies 100a, 100b. Additionally, in the illustrated embodiment, the frame assembly 160 includes at least one cross member 162 that directly or indirectly interconnects the first and second side rail assemblies 100a, 100b. However, as indicated below, according to other embodiments, the frame assembly 160 can include other features or components, including, but not limited to, a plurality of cross members 160, mounts, flanges, and bumpers, among other features. Additionally, while the illustrated embodiment depicts at least portions of the first insert 104 adjacent to the front and rear sections 102, 106 being exposed or visible when the side rail assemblies 100a, 100b are assembled, according to other embodiments, the first insert 104 may be concealed within the front and rear sections 102, 106.

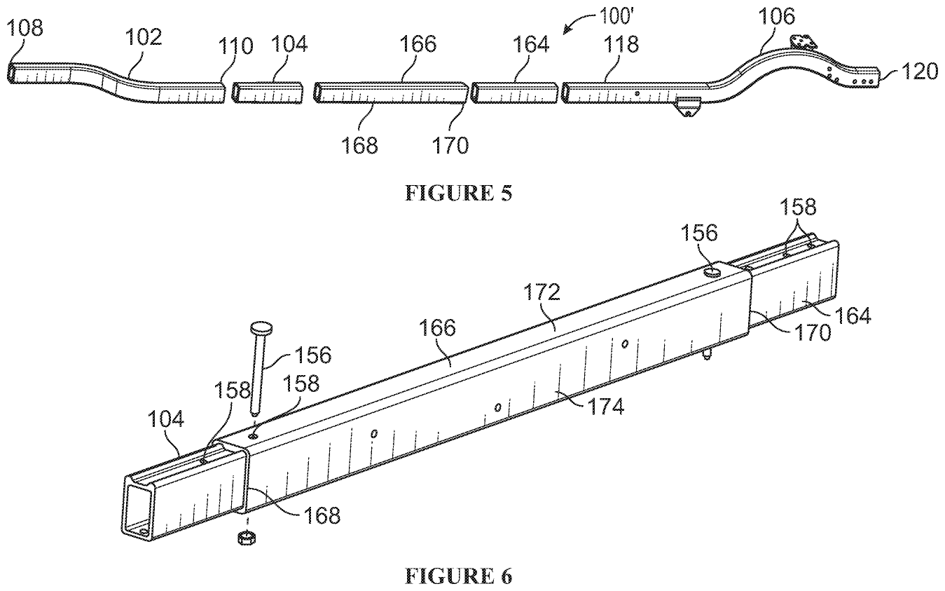

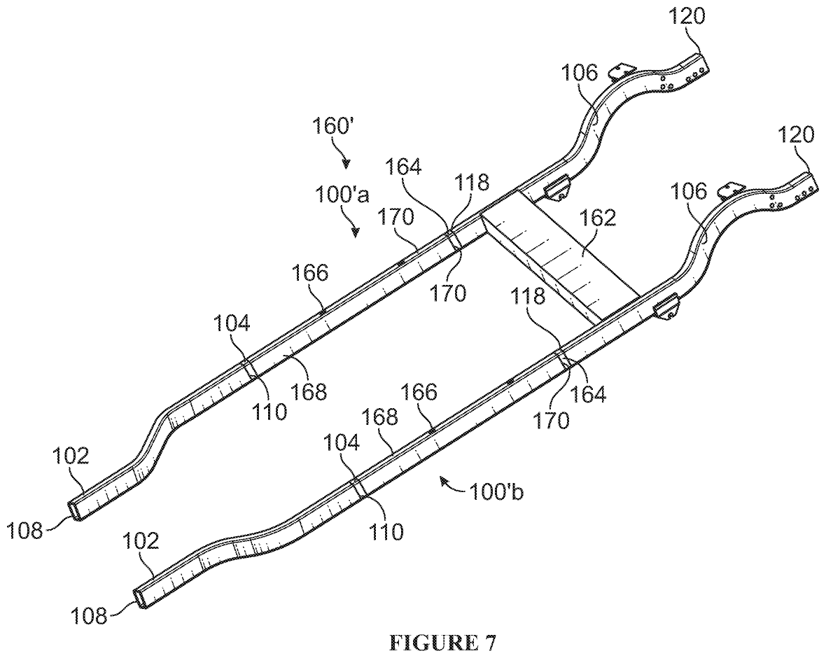

FIG. 5 illustrates an exploded perspective view of components for expansion of the side rail assembly 100 shown in at least FIG. 1, and thus the associate frame assembly 100, from a first configuration to a second, longer configuration. Moreover, expanding the overall length of the side rail assembly 100 shown in FIG. 1 to provide the side rail assembly 100′ shown in FIG. 5, accommodates, when selectively implemented, an extension or increase in the length of the associated frame assembly 160′ (FIG. 7). According to the illustrated embodiment, the second configuration of the side rail assembly 100′ comprises, in addition to the front and rear sections 102, 106 and the first insert 104 of the first configuration of the rail assembly 100, the inclusion of at least a second insert 164 and a rail sleeve 166.

According to certain embodiments, the second insert 164 can have a construction and configuration that is similar, if not generally identical, to that of the first insert 104. Thus, according to certain embodiments, the second insert 164 can be selectively attached to the front and/or rear section 106 of the frame assembly 160′ in a manner that is similar, if not the same as, the above discussed manner regarding the attachment and detachment of the first insert 104 to/from the front and rear sections 102, 106 of the frame assembly 100. Accordingly, attachment of the second insert 164 to the front section 102 or rear section 106 can also involve aligning fastener holes 158 of the second insert 164 with corresponding fastener holes 158 of the front or second section of the side rail assembly 100′, and the subsequent insertion of a fastener 156 through the aligned fastener holes 158. Additionally, as shown in at least FIG. 6, the second insert 164 can have one or more protrusions 142 and an associated channel 144 along one or more walls 130 of the second insert 164 that is similar to that discussed above with respect to the first insert 104. Alternatively, according to other embodiments, the first and second inserts 104, 164 and the front and rear sections 102, 106 can have configurations that can accommodate the first insert 104 being able to matingly engaging only one of the front and rear sections 102, 106, and the second insert 164 being able to matingly engage the front or rear section 102, 106 that is not matingly engageable with the first insert 104.

As shown in at least FIG. 6, the rail sleeve 166 extends a length between a first end 168 and a second end 170 of the rail sleeve 166 that can at least accommodate portions of both the first insert 104 and the second insert 164 being inserted into, and secured to, opposing ends of the rail sleeve 166. Additionally, the rail sleeve 166 can have a wall 174 that defines an inner region of the rail sleeve 166 that is sized to accommodate insertion of the first and second inserts 104, 164 into the rail sleeve 166. The inner region of the rail sleeve 166 can have a shape and configuration that is, at least in part, similar to the interior regions of the front and rear sections 102, 106. More specifically, according to certain embodiments, at least the inner region at or around the first and second ends 168, 170 of the rail sleeve 166, if not along the entire length of the rail sleeve 166, can also have one or more recesses and protrusions similar to the recesses 152 and protrusions 154 of the front and rear sections 102, 106 that are positioned and sized to matingly receive, and possibly engage, the corresponding protrusions 142 and associated channel or depression 144 of the first and second inserts 104, 164.

Similar to the front and rear sections 102, 106, a top portion 172 of the wall 174 of the rail sleeve 166 can have a plurality of fastener holes 158 that are positioned to be aligned with one or more fastener holes 158 of the first and second inserts 104, 164. Additionally, fasteners 156 similar to those used to connect the front and rear sections 102, 106 to the first insert 104, such as, for example, a bolt that is inserted through fastener holes 158 in opposing top and bottom portions 132, 134 of the first insert 104 and adjacent portions of the front/rear sections 102, 106 can also be inserted through the fastener holes 158 of the rail sleeve 166 and the first/second inserts 104, 164 and secured via, for example, at least use of a mating nut.

FIG. 7 illustrates a perspective view the frame assembly 160′ that, compared to at least the frame assembly 160 shown in FIG. 4, has been expanded to the second, longer length via the pair of side rail assemblies 100′a, 100′b each being in the second configuration. According to such an embodiment, one of the first and second inserts 104, 164 can be connected, such as, for example, via one or fasteners 156 through corresponding fastener holes 158, to the front section 102, while the other of the first and second inserts 104, 164 is attached in a similar manner to the rear section 106. The rail sleeve 166 is thus positioned between the front and rear sections 102, 106 and connected to the first and second inserts 104, 164, such as, for example, via one or more of the fasteners 156. With the rail sleeve 166 for each rail assembly 100′a, 100′b connected to both the first insert 104 and the second insert 164, and the first and second inserts 104, 164 coupled to the front and rear sections 102, 106, respectively, as shown in FIG. 7, the respective side rail assembly 100′a, 100′b, as well as at least the overall frame assembly 160′, can be in a second configuration. Such a second configuration can correspond to the assembled rail assemblies 100′a, 100′b, and/or the frame assembly 160′, having a second overall length, such as, for example, a second linear length between the first end 108 of the front section 102 and the second end 120 of the rear section 106. Further, as shown by at least a comparison of FIGS. 4 and 7, this second, expanded length of the second configuration of the side rail assemblies 100′a, 100′b, and thus the frame assembly 160′, is longer than the previously discussed first length associated with the first configuration of the rail assembly(ies) 100a, 100b and the frame assembly 160.

In the embodiment depicted in FIG. 7, a portion of both the first and second inserts 104, 164 of the side rail assemblies 100′a, 100′b are visible in spaces between the rail sleeve 166 and the front and rear section 102, 106, respectively. However, similar to the first configuration of the frame assembly 160 shown in FIG. 4, according to certain embodiments, the front section 102 may be positioned relative to the first end 168 of the rail sleeve 166, and the rear section 106 may be positioned relative to the second end 170 of the rail sleeve 166, such that the associated first insert 104 and/or second insert 164 may, or may not, be visible when the frame assembly 160′ is assembled.

In the illustrated embodiment, the first and second inserts 104, 164 are inserted into the rail sleeve 166 and the adjacent one of the front and rear sections 102, 106, of the side rail assembly 100′a, 100′b. However, according to other embodiments, it may be the rail sleeve 166 and/or the front and rear sections 102, 106 that have a configuration that is received in the first and/or second insert 104, 164. According to such embodiments, at least a portion of the outer surface of the wall 146, 174 of rail sleeve 166, front section 102, and/or rear section 106 may be similar to that of the first insert 104 that was discussed above with respect to FIG. 3A, and at least a portion of the inner surface 148 of the wall 130 of the first and/or second inserts 104, 164 may have a configuration similar to that discussed above with respect to FIG. 3B.

While the foregoing examples have been discussed in terms of the first insert 104, second insert 164, and rail sleeve 166 being separate components, according to other embodiments, two or more of the first insert 104, second insert 164, and rail sleeve 166, and/or the features thereof, can be part of a single component, including a single monolithic component. For example, according to certain embodiments, the rail sleeve 166 can include the above-discussed features of the second insert 164 such that the rail sleeve 166 can be coupled to the front and/or rear section 102, 106 in a manner similar to that as described above with respect to the second insert 164 while the overall frame assembly 160 still maintains the expanded second length associated with the above-discussed second configuration. Additionally, or alternatively, according to certain embodiments, the rail sleeve 166 can include the features of the first insert 104 such that the rail sleeve 166 can be coupled to the front and/or rear section 102, 106 in a manner similar to that as described above with respect to the first insert 104 while the overall frame assembly 160 still maintains the expanded second length associated with the above-discussed second configuration.

Alternatively, according to other embodiments, the first insert 104 can have an overall length that can accommodate the front and rear sections 102, 106 being adjusted about the first insert 104 in a manner that can eliminate use of the second insert 164 and rail sleeve 166. For example, according to certain embodiments, the first insert 104 can be telescopically arranged relative to both the front section 102 and the rear section 106 such that the position of one or both of the front and rear sections 102, 106 can be adjustably sliding displaced over, or alternatively within, at least a portion of the first insert 104. Thus, according to such an embodiment, when the front and rear sections 102, 106 are at a linear position over, or within, the first insert 104 that corresponds to the first configuration and the associated first length, the front and rear sections 102, 106 can be secured to first insert 104 via mechanical fasteners 156. In the event the side rail assemblies 100a, 100b, and thus the frame assembly 160, are/is to be expanded to the second configuration, and thus to the longer second length, the mechanical fasteners 156 can be removed such that the front and/or rear sections 102, 106 can be linearly displaced relative to the first insert 104 to a location that corresponds to the second configuration. With the front and/or rear section(s) 102, 106 positioned at an adjusted location(s) relative to the first insert 104 that corresponds to the second configuration, mechanical fasteners 156 can then be used to again secure the adjusted front and/or rear section(s) 102, 106 to the first insert 104.

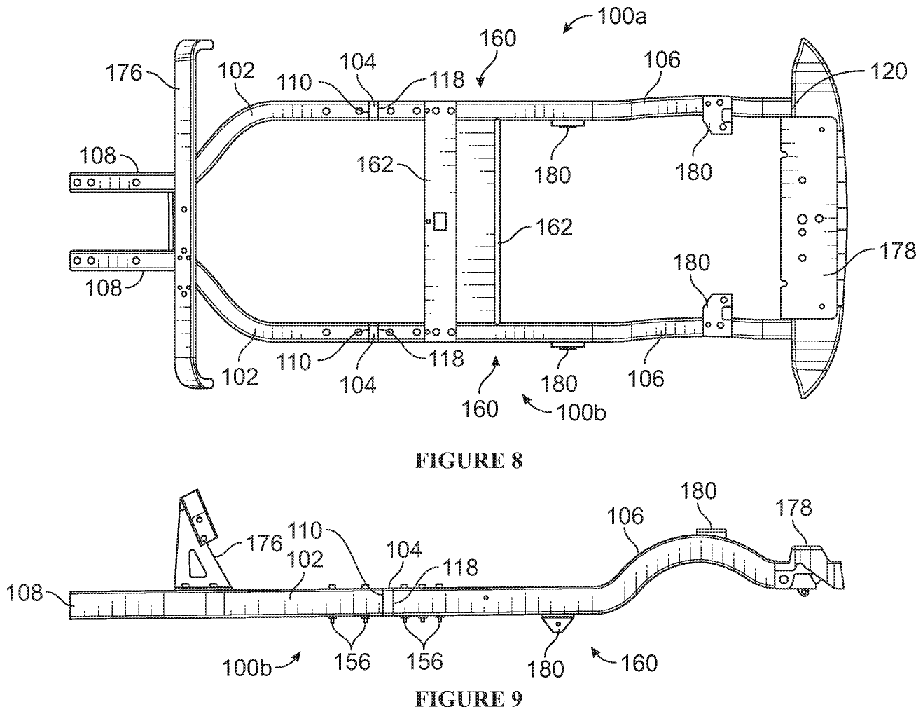

FIGS. 8 and 9 illustrate top and side views, respectively, of an exemplary assembled frame assembly 160 having side rail assemblies 100a, 100b in the first configuration according to an embodiment of the present application. As previously discussed, during manufacturing, the side rails can, according to certain embodiments, initially have an unitary construction, such that, for example, the front and rear sections 102, 106 that eventually become part of the side rail assemblies 100a, 100b are at least initially part of the same monolithic structure. Subsequently, these monolithic side rail(s) can be separated, such as, for example cut, so that physically separate front and rear sections 102, 106 can be provided at least initially for the side rail assemblies 100a, 100b, and thus for the frame assembly 160. The side rail assembly(ies) 100a, 100b can then be reassembled via connecting the first insert 104 to each of the front and rear sections 102, 106, thereby assembling at least the side rail assembly 100a, 100b, if not the frame assembly 160 itself, in the first configuration. More specifically, as shown in at least FIGS. 8 and 9, at least a portion of the first insert 104 for each side rail assembly 100a, 100b is positioned within the front and rear sections 102, 106. Additionally, as also show, the first insert 104 can be connected to both the front section 102 and the rear section 106, such as, for example, via a plurality of fasteners 156, such as, for example, bolt and nut combinations.

The frame assembly 160 is also depicted as having a plurality of components, including, but not limited to, a plurality of cross members 162, a front beam 176, a rear beam 178, and a plurality of mounting brackets 180, among other components. The front and rear beams 176, 178 can be utilized for a variety of purposes, including, but not limited, support structures for bumpers, platforms, and vehicle body components. Similarly, the mounting brackets 180 can be coupled to a variety of different components of the vehicle, including, but not limited to, a transmission, suspension and/or vehicle body components, battery, and/or motor or engine, among other components.

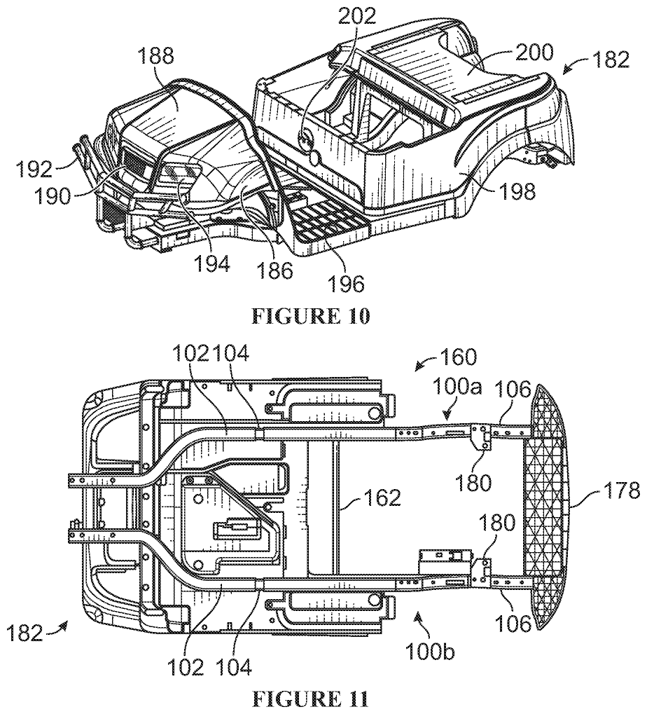

With the side rail assemblies 100a, 100b, and thus the overall frame assembly 160, in the first configuration, certain stages of assembly can proceed, such as, for example, along an assembly line. The amount of components assembled to the vehicle as the vehicle proceeds along the assembly line can vary. For example, as shown by at least FIGS. 10 and 11, with the side rail assemblies 100a, 100b, and thus the overall frame assembly 160, in the first configuration, a relatively large portion of the assembly of the vehicle 182 can be completed along the assembly line. Such assembly can generally at least include, for example, components that are to be directly and/or indirectly attached to the front and rear sections 102, 106 that will not interfere with, or have the ability to be expandable to accommodate, selective expansion of the side rail assemblies 100a, 100b, and thus the overall frame assembly 160, to the above-discussed second configuration and the associated larger, second length. For example, with the side rail assemblies 100a, 100b, and thus the overall frame assembly 160, in the first configuration, the front quarter panels 186 hood 188, front grill 190, front bumper 192, front headlights 194, first floor pan 196, rear quarter panels 198, trunk or rear platform 200, driver accessible shifter 202, motor or engine, transmission, coolant system, rear floor pan, battery, front and rear portions of a suspension system, and front and rear rims and tires, among other components can be assembled to the vehicle 182.

According to certain embodiments, with the vehicle 182 in at least a partial assembled configuration, such as that shown for example, in FIG. 10, the vehicle 182 can continue to proceed along the assembly line until completion. Alternatively, with the vehicle 182 in a partial assembled configuration, as shown for example in FIG. 10, a decision can be made to adjust the length of the side rail assemblies 100a, 100b, and thus the frame assembly 160 of the at least partially assembly vehicle 182 shown in FIGS. 10 and 11 from the first configuration to the second configuration. Moreover, such a decision may be made to expand the length of the vehicle 182 from the first length that is associated with the side rail assemblies 100a, 100b, and thus the frame assembly 160, being in the first configuration, to the longer, second length that is associated with the side rail assemblies 100′a, 100′b, and thus the frame assembly 160′, being in the second configuration. Such expansion can involve disconnecting, such as via removal of the fasteners 156, that were being used to secure the first insert 104 to one of the front section 102 and the rear section 106 so that the rail sleeve 166 and second insert 164 can be added to the side rail assemblies 100′a, 100′b, as previously discussed. Further, according to certain embodiments, such an expansion can occur after a fully functional vehicle 182 has already been assembled on the assembly line with the side rail assemblies 100a, 100b, and thus the frame assembly 160, being in the first configuration. Indeed, according to certain embodiments, the timing at which the vehicle 182 is to be either completed or expanded can occur when the remaining component to be assembled to the vehicle 182 is generally the inclusion of a canopy. Thus, according to certain embodiments, and as discussed below, if the vehicle is to be expanded, the remaining components for assembly may, according to certain embodiments, generally be limited to assembly of an additional, or supplementary floor pan, addition of a seat or bench seat, a repositioning of a driver accessible shifter and associated shifter cable.

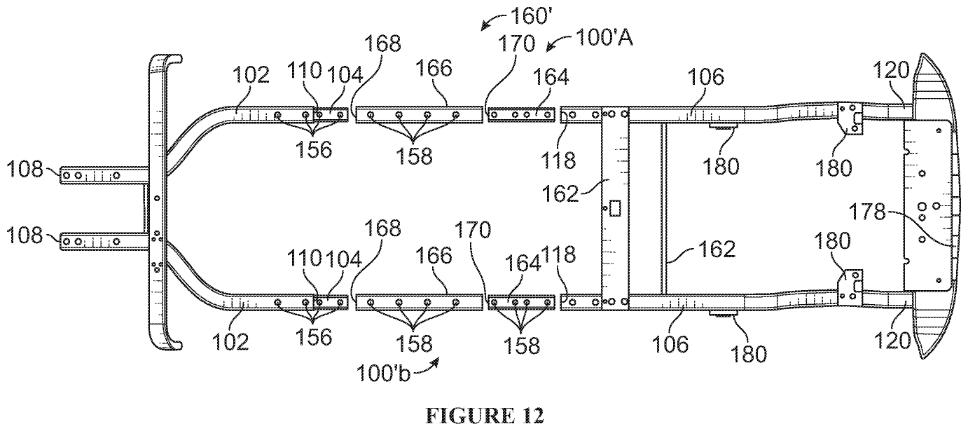

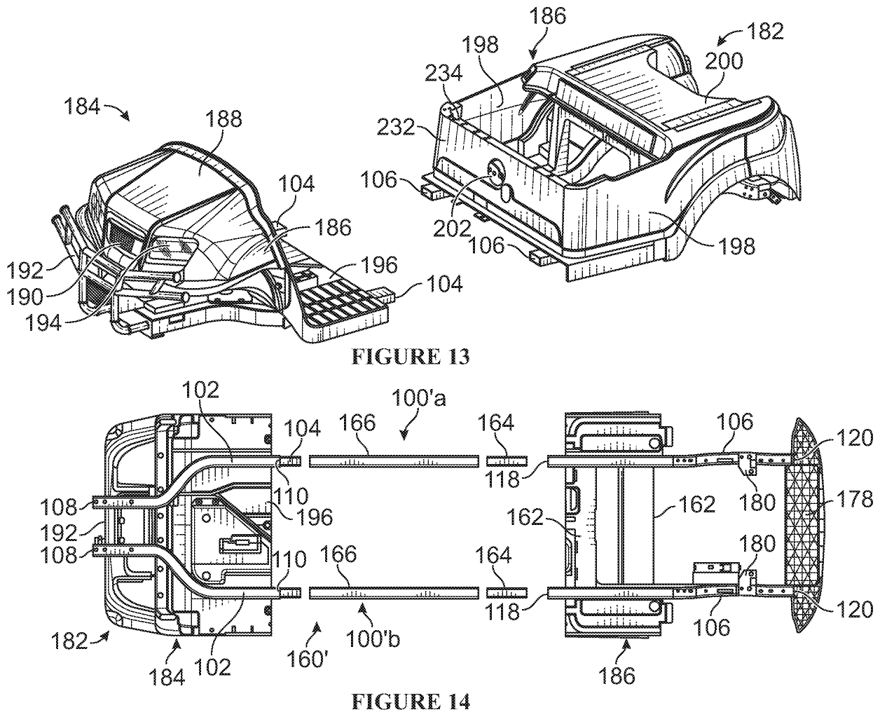

For example, FIGS. 12-14 depict an example in which, after at least partial assembly of the vehicle 182 along the assembly line, the fasteners 156 are removed from the connection between the first inserts 104 and the rear sections 106 of the rail assemblies 100a, 100b of the frame assembly 160, while the first inserts 104 have remained connected via other fasteners 156 to the front sections 102 of the side rail assemblies 100a, 100b. As shown by at least FIG. 13, with the detachment of the first inserts 104 from the rear sections 106, and in the absence of components preventing separation of at least the side rail assemblies 100a, 100b, and/or components that are expandable with such expansion, the at least partially assembled vehicle 182 can be separated into an assembled front section 184 and an assembled rear section 186. Moreover, as shown in the exemplary embodiment depicted in FIG. 13, a number of assembled components that have been directly or indirectly connected to the front sections 102 and first inserts 104 of the side rail assemblies 100a, 100b during assembly along the assembly line can be separated from the assembled rear section 186 of the vehicle 184, which, in this example, can comprise components of the vehicle 182 that had been directly or indirectly connected to the rear sections 106 of the side rail assemblies 100a, 100b during assembly along the assembly line. While FIG. 13 does not depict the tires/wheels assembled to the vehicle 182, as indicated above, such expansion can occur after a functional vehicle 182 having such features has been at least partially, if not completely, assembled.

Further, for example, as shown in the exemplary embodiment depicted at least FIG. 13, the separated front section 102 of the vehicle 182 can include at least the front portion of the body components of the vehicle 182, including, for example, the front quarter panels 186, hood 188, front grill 190, front bumper 192, front headlights 194, and the first floor pan 196. The assembled front section 184 can also include a variety of other components that are not shown, or are not visible, in FIG. 13, including, for example, components of the front portion of the suspension system, front rims and tires, steering wheel and column, and/or front interior dash, among other components. Similarly, the separated assembled rear section 186 of vehicle can include a variety of other components that were assembled to the vehicle 182 along the assembly line, including, for example, the rear quarter panels 198, trunk or rear platform 200, driver accessible shifter 202, motor or engine, transmission, coolant system, rear floor pan, battery, the rear portion of a suspension system, and rear tires and rims, among other components.

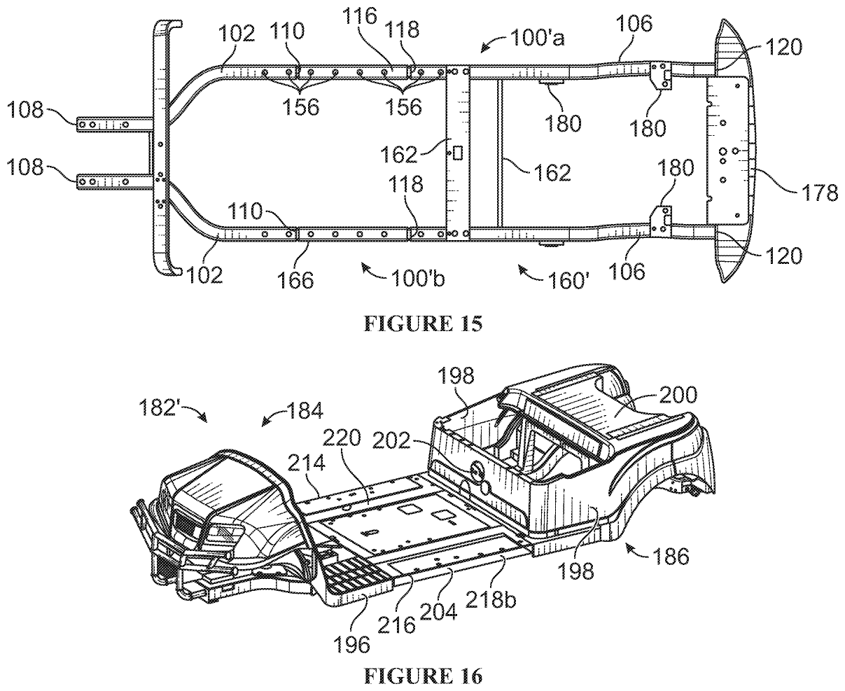

As indicated by at least FIG. 14, with the vehicle 182 separated into the assembled front and rear sections 184, 186, rail sleeves 166 and second inserts 164 can be provided for expanding each of the side rail assemblies 100a, 100b, and thus the frame assembly 160, to the second, longer configuration. Thus, as indicated by at least FIG. 15, in the exemplary embodiment, opposing first and second ends 168, 170 of each of the rail sleeves 166 can receive an adjacent one of the first and second inserts 104, 164. Each of the rail sleeves 166 can then be connected, such as, for example, via at least fasteners 156, as previously discussed, to the associated first and second inserts 104, 164. Further, in the illustrated embodiment, the second inserts 164 can each be received by, and similarly connected to via fasteners 156, the adjacent rear section 106.

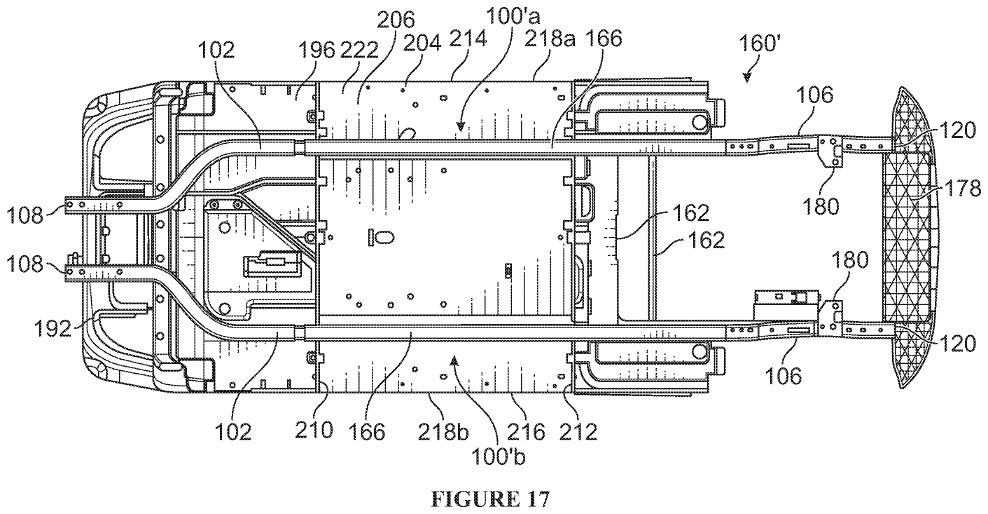

Further, as shown by at least FIGS. 16-17, with the assembled front and rear sections 102, 106 reconnected via the inclusion, and connection, of the second inserts 164 and rail sleeves 166 so as to provide expanded side rail assemblies 100′a, 100′b, and thus an expanded frame assembly 160′, having the second configuration, a second, or supplementary floor pan 204 can be connected to the expanded vehicle 182′. In the depicted embodiment, the supplementary floor pan 204 can generally extend in the expanded space above at least the assembled and expanded side rail assemblies 100′a, 100′b. Moreover, according to the illustrated embodiment, the supplementary floor pan 204 can fill the expanded space between at least the front and rear sections 102, 106 of the side rail assemblies 100a′, 100′b in the general region of a floor of the vehicle 182′ directly above the rail sleeves 166.

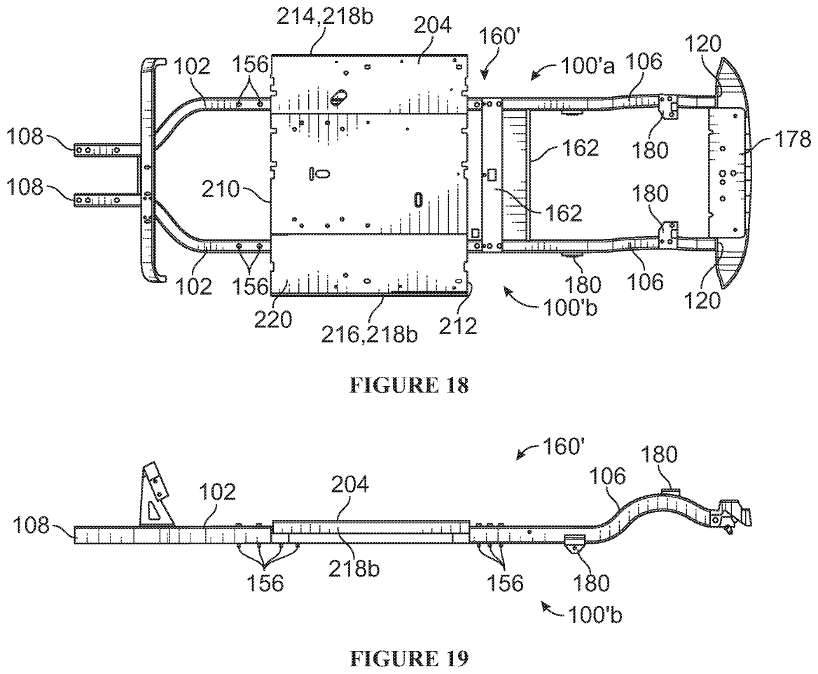

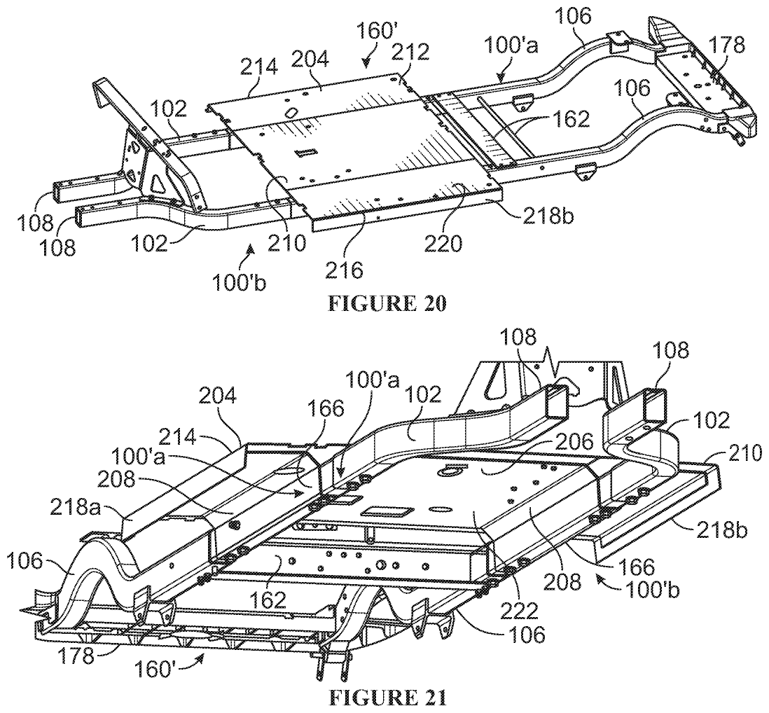

Alternatively, as indicated by at least FIGS. 18-21, the supplementary floor pan 204 can be connected to a pair of rail sleeves 166 prior to the rail sleeves 166 being assembled to their respective side rail assemblies 100′a, 100′b. For example, as shown, according to the illustrated embodiment, a bottom surface 206 of the supplementary floor pan 204 can include, for each rail sleeve 166, a generally downwardly extending support channel 208 that can abut, or otherwise be adjacent to, a top portion 172 of the wall 174 of the rail sleeves 166. Such support channels 208, among other features on the bottom surface 206 of the supplementary floor pan 204, can be used to securely attach the supplementary floor pan 204 to the rail sleeves 166, such as, for example, via a mechanical connection, including by use of one or more bolts, pins, screws, and/or rivets, or via a welded connection, among other forms of connection. The supplementary floor pan 204 can also have a length between front and rear sides 210, 212 of the supplementary floor pan 204 that are generally similar, if not the same, as the overall length between the first and second ends 168, 170 of the rail sleeve 166. Additionally, opposing sides 214, 216 of the supplementary floor pan 204 that extend between the front and rear sides 210, 212 can each include a generally downwardly extending side flange 218a, 218b. The side flanges 218a, 218b can generally extend downwardly from a top surface 220 of the supplementary floor pan 204 and define an interior region 222 beneath the bottom surface 206 of the supplementary floor pan 204 that generally includes the above-mentioned support channels 208.

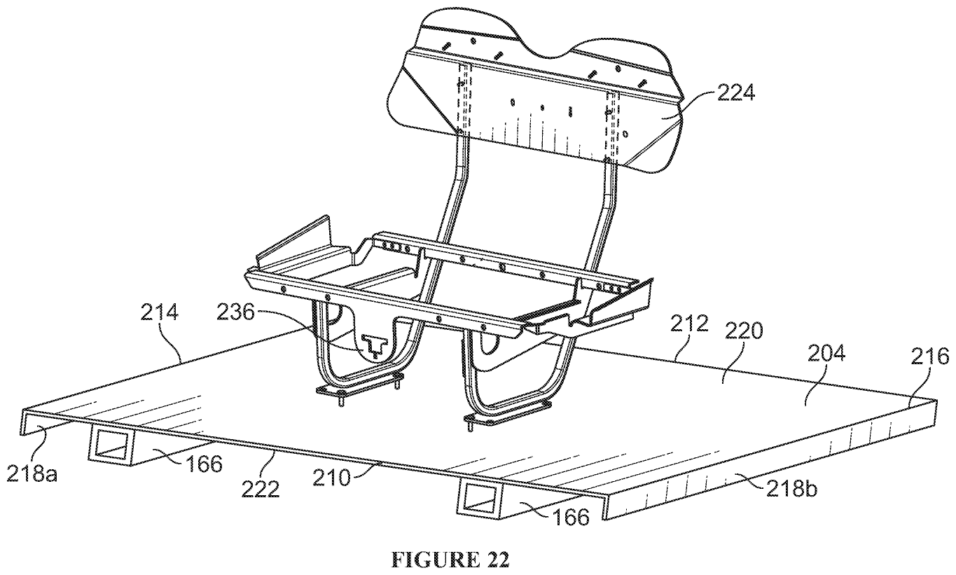

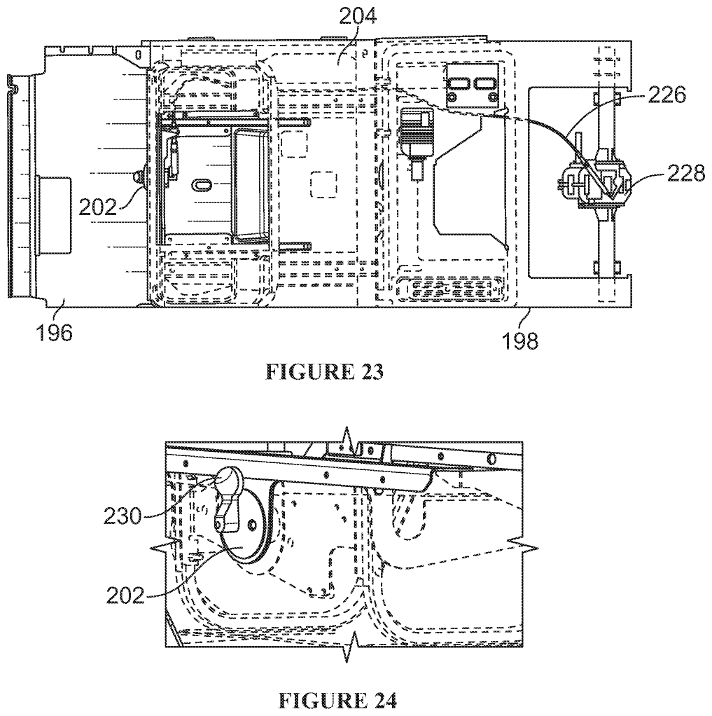

The supplementary floor pan 204 can be configured for a variety of uses for the expanded vehicle 182′. For example, as shown in at least FIG. 22, the supplementary floor pan 204 can be coupled to one or more supplementary seats 224, including, but not limited to, a second multi-passenger bench seat, that can be utilized with a vehicle(s) 182′ that has been, or is in the process of being, expanded to the second, longer configuration. Such a second, supplementary seat(s) 224 can be secured to the supplementary floor pan 204 in a variety of different manners, including, for example, via use of one or more mechanical fasteners, including, but not limited to, bolts, screws, pins, and clips, among other fasteners. Alternatively, the second, supplementary seat(s) 224 can be secured to the supplementary floor pan 204 via one or more welds.

While the foregoing examples discuss a first floor pan 196 and a supplementary floor pan 204, the number of floor pans can vary. Additionally, according to certain embodiments, the first floor pan 196 and/or the supplementary floor pan 204 can be comprised of a collection of individual or separate floor pans, and/or separate components that provide the associated floor pan 196, 204. Additionally, according to certain embodiments, one or more additional floor pans can be included that covers other floor pans 196, 204, such as, for example, one or more floor pans that provides a continuous appearance and/or surface over and/or beneath the other floor pans 196, 204.

As previously mentioned, at least certain components assembled to the vehicle 182 prior to separation of the assembled front and rears sections 184, 186 can be configured to be expandable with, or otherwise accommodate, such separation of the vehicle 182. For example, FIG. 24 illustrates an expandable shifter cable 226 that can, for example, at one end be coupled to at least a driver accessible shifter 202, and at another end be coupled to a component utilized to adjust transmission, engine or motor 228, or other related components of the vehicle 182, 182′ associated with at least the direction in which one or more of the wheels or tires of the vehicle 182, 182′ will be driven by the operation of the engine or motor 228 of the vehicle 182, 182′. The shifter cable 226 can have a length that can not only accommodate the positioning of the driver accessible shifter 202 when the side rail assemblies 100a, 100b, and thus the frame assembly 160, is in the first configuration, as shown by at least FIG. 10, but which can also be extended and moved to a different location on the supplementary seat 224 when the side rail assemblies 100′a, 100′b, and thus the frame assembly 160′, are in the second, longer configuration.

The vehicle 182 can also include other expandable components, that are coupled to components that may be located in the assembled front and rear sections 184, 186 of the vehicle 182, 182′. For example, according to certain embodiments, the vehicle 182, 182′ can include, but is not limited to, an expandable wiring harness that is coupled to both components located in the assembled front section 184, such as, for example, gages, a radio, a visual display monitor, or other entertainment or communication devices, as well as coupled to components that are located in the assembled rear section 186 of the vehicle 182, such as, for example, a battery, antenna, controller, and/or transceiver, among other components. Similarly, other expandable components can include cables and/or wires used to transmit a force and/or signal associated with use of a foot pedal(s) or paddle(s) that may be engaged by the driver when driver intends to utilize the power of the motor or engine to attain movement of the vehicle 182, 182′, such as, for example, drive the vehicle 182, 182′. Such expandable components, can thus also be configured to accommodate changes in the locations of the devices to which the expandable components are coupled to in the event the length of the vehicle 182 is expanded, such as, for example, from the configuration shown in FIG. 10 to the configuration shown in FIG. 16.

With respect to the shifter cable 226, according to the illustrated embodiment, such expansion of the shifter cable 226 can be facilitated by use of a shifter cable 226 that, at least when initially assembled to the vehicle 182 on the assembly line while the side rail assemblies 100a, 100b, and thus the frame assembly 160, are in the first configuration, has an excess length that can accommodate extension of the shifter cable 226. Moreover, the shifter cable 226 can have at least an initial length that can accommodate later relocation of at least the driver accessible shifter 202 to a different position, such as a position on the supplementary seat 202 that is further from the motor or engine 228 or other engine compartment component(s). Moreover, as shown in FIG. 22, the supplementary seat(s) 224 can include a mounting bracket 126 having a configuration that can accommodate the mounting of the driver accessible shifter 202 to the mounting bracket 126 in the event the vehicle 182 is expanded via the expanded side rail assemblies 100′a, 100′b and frame assembly 160′. Thus, the shifter cable 226 can have a length that can accommodate such repositioning of the driver accessible shifter 202 without having to replace the shifter cable 226.

As shown in at least FIG. 24, according to the illustrated embodiment, the driver accessible shifter 202 can include a driver accessible shifter or lever 230 that can be displaced to positions that can be associated with having power provided by the engine or motor 228, when the user depresses or otherwise activates a pedal or paddle of the vehicle 182, 182′, drive one or more tires or wheels of the vehicle 182, 182′ in one or more directions.

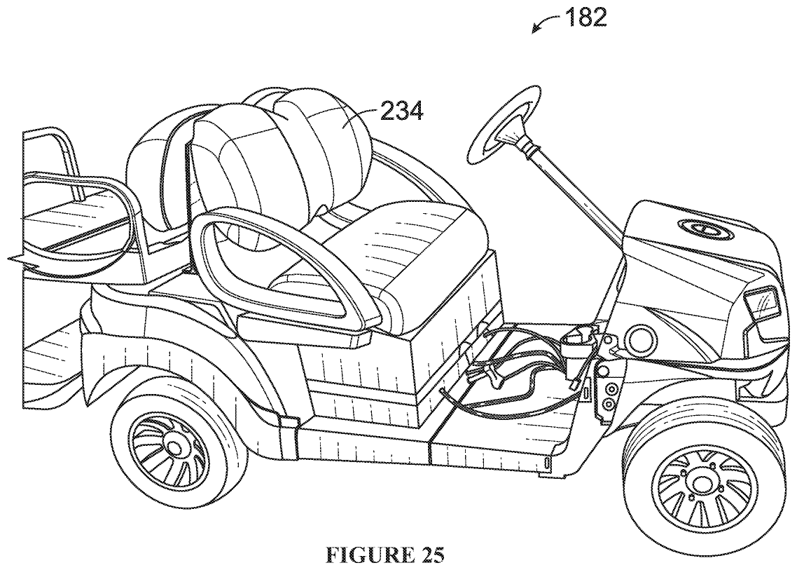

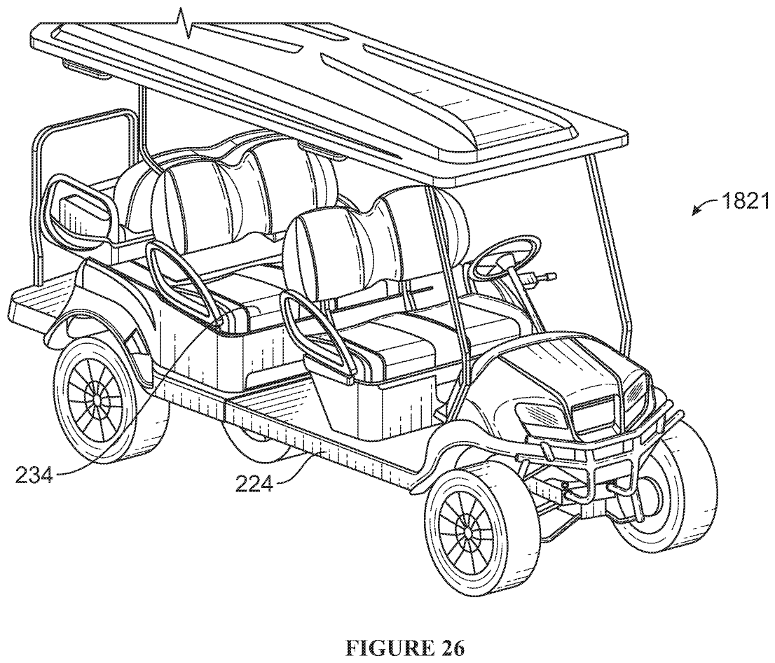

FIGS. 25 and 26 provide examples of changes in vehicle 182 when the side rails 100a, 100b, and thus frame assembly 160, are expanded from the first configuration to provide a vehicle 182′ having the side rails 100′a, 100′b, and thus frame assembly 160′, in the second configuration. As shown by the example vehicle 182 depicted in FIG. 25, according to the illustrated embodiment, when the vehicle 182 is constructed with the side rails 100a, 100b, and thus frame assembly 160, in the first configuration, the vehicle 182 has a first length that can accommodate one, or a first, forward facing two-person bench seat 234, in addition to a rearward facing seat at the back region of the vehicle 182. However, if that same vehicle 182 had, after at least partial assembly along the assembly line, as discussed above, been expanded so as to provide the second configuration of the side rails 100′a, 100′b and the frame assembly 160′, as seen in FIG. 26, the vehicle resulting 182′ would have retained many, if not all, of at least the components shown in FIG. 25, as well as had additional space to accommodate the additional inclusion of a second, or supplementary, forward facing two-person bench seat 224, as shown, for example, in FIG. 26.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim.

1. A device comprising:
a frame assembly having a first side rail assembly and a second side rail assembly, the first side rail assembly and the second side rail assembly positioned on opposing sides of the frame assembly, the first side rail assembly and the second side rail assembly each being selectively expandable from a first configuration to a second configuration,
wherein the first configuration for each of the first side rail assembly and the second side rail assembly comprises a front section, a first insert, and a rear section, the first insert being selectively, and removably, attached to both the front section and the rear section,
wherein the second configuration for each of the first side rail assembly and the second side rail assembly comprises the front section, the first insert, the rear section, a second insert, and a rail sleeve, the first insert being selectively, and removably, attached to one of the front and the rear sections and the second insert being selectively, and removably, attached to the other of the front and rear sections, the rail sleeve being coupled to the first insert and the second insert and positioned between the front and rear sections, and
wherein a length between opposing ends of the first side rail assembly and the second side rail assembly for the second configuration is larger than a corresponding length for the first configuration.

2. The device of claim 1, wherein the first insert is sized and configured to be at least partially inserted into both the front section and the rear section.

3. The device of claim 1, wherein the first configuration further includes a plurality of removable mechanical fasteners that securely attached the first insert to the front and rear sections.

4. The device of claim 1, wherein the rail sleeve and the second insert are, together, a monolithic component.

5. The device of claim 1, wherein the first side rail assembly is connected to the second side rail assembly at least by one or more cross members

6. The device of claim 1, wherein at least one of the front section and rear section comprises a plurality of mounting brackets.

7. The device of claim 6, wherein the device further includes at least a portion of a vehicle body that is coupled to at least one of the plurality of mounting brackets.

8. The device of claim 7, further including at least one floor pan coupled to the frame assembly.

9. The device of claim 1, further including a shifter cable having a length that accommodates extension of the shifter cable with the expansion of the first and second side rail assemblies from the first configuration to the second configuration.

10. A method comprising:
assembling, using a plurality of mechanical fasteners, a first side rail assembly and a second side rail assembly of a frame assembly;
mounting a plurality of vehicle components to the frame assembly to provide an at least partially assembled vehicle;
disconnecting, by removing at least some of the plurality of mechanical fasteners and after providing the at least partially assembled vehicle, a portion of each of the first side rail assembly and the second side rail assembly from another portion of the associated first side rail assembly and the second side rail assembly; and
expanding the frame assembly by reconnecting the disconnected portions of each of the first side rail assembly and the second side rail assembly to at least a rail sleeve that is positioned at least between a portion of each of the previously disconnected portions of the first side rail assembly and the second side rail assembly.

11. The method of claim 10,
wherein the step of disconnecting each of the first side rail assembly and the second side rail assembly includes separating an assembled front section of the at least partially assembled vehicle from an assembled rear section of the at least partially assembled vehicle, and
wherein the step of expanding the frame assembly includes positioning the rail sleeve for each of the first side rail assembly and the second side rail assembly in a space between the separated assembled front and rear sections of the at least partially assembled vehicle.

12. The method of claim 11,
wherein the mounting step includes mounting a first floor pan to the first and second side rail assemblies,
wherein, when the assembled front section of the at least partially assembled vehicle is separated from the assembled rear section of the at least partially assembled vehicle, the first floor pan is connected to only one of the assembled front section and the assembled rear section, and
wherein the expanding step includes securing at least a portion of a second floor pan at a location between the assembled front section and the assembled rear section.

13. The method of claim 12, wherein the assembled rear section includes at least a portion of a first seat, and wherein the step of expanding further includes securing at least a portion of a second seat to the second floor pan.

14. The method of claim 13,
wherein the mounting step includes mounting a driver accessible shifter to a portion of the first seat, securing an end of a shifter cable to the driver accessible shifter, and securing another end of the shifter cable to at least another one of the plurality of vehicle components that are coupled to another portion of the frame assembly, the shifter cable having a length size to accommodate use with the frame assembly in both the first and second configurations, and
wherein the expanding step includes moving and remounting the driver accessible shifter to the second seat, and extending a pre-existing length of the shifter cable to accommodate and change in position associated with the moving and remounting of the driver accessible shifter.

15. The method of claim 11, wherein the first side rail assembly and the second side rail assembly each comprises a front section, a first insert, and a rear section, and wherein the step of disconnecting for each of the first and second side rail assemblies comprises detaching, via the removal of at least some of the plurality of mechanical fasteners, the first insert from one of the front section and the rear section.

16. The method of claim 15, wherein the step of expanding, for each of the first and second side rail assemblies, further comprises:
attaching a second insert to one of the front section and the rear section;
attaching the second insert and the first insert to opposing ends of the rail sleeve such that at least portions of the rail sleeve, the first insert, and the second insert are positioned between the front section and the rear section.

17. The method of claim 16, wherein the step of attaching the second insert to one of the front section and the rear section comprises inserting a portion of the second insert into the front section or the rear section and inserting a mechanical fastener through the front or rear section and into the inserted portion of the second insert.

18. The method of claim 17, wherein the step of attaching the second insert and the first insert to the rail sleeve includes inserting a portion of the first insert into a first end of the rail sleeve and inserting a portion of the second insert into a second portion of the rail sleeve and inserting mechanical fasteners through the rail sleeve and into the inserted portions of the first insert and the second insert.

19. The method of claim 10, wherein the first side rail assembly and the second side rail assembly each comprises a front section, a first insert, and a rear section, the first insert being telescopically arranged relative to at least one of the front section and rear section,
wherein the step of assembling the first side rail assembly and a second side rail assembly of the frame assembly comprises coupling both the front and rear sections to the first insert, and
wherein the step of expanding the frame assembly comprises telescopically displacing at least one of the front section and the rear section from a first position to a second position relative to the first insert and securing the telescopically displaced front section and/or the rear section to the first insert at the second position.

20. The method of claim 10, wherein the assembling step comprises:
separating a front section from a rear section of each of the first and second side rail assemblies;
attaching, via one or more mechanical fasteners, a first end of a first insert to the front section; and
attaching, via one or more mechanical fasteners, a second end of a first insert to the rear section.
